(19) United States
(12) Patent Application Publication
(10) Pub. No.: US 2016/0221427 A1
(43) Pub. Date: Aug. 4, 2016

(54) PEST PROTECTION

(71) Applicants: AMY ROBINSON, PEACE RIVER (CA); ASHLEY YUREMCHUK, PEACE RIVER (CA); GARY ROBINSON, PEACE RIVER (CA); MICHELLE ROBINSON, PEACE RIVER (CA)

(72) Inventors: AMY ROBINSON, PEACE RIVER (CA); ASHLEY YUREMCHUK, PEACE RIVER (CA); GARY ROBINSON, PEACE RIVER (CA); MICHELLE ROBINSON, PEACE RIVER (CA)

(21) Appl. No.: 14/614,203

(22) Filed: Feb. 4, 2015

(51) Int. Cl. B60J 11/04; B60R 99/00

(52) U.S. Cl. CPC B60J 11/04; B60R 99/00; B60R 2099/005

(57) ABSTRACT

Disclosed is a pliable bag comprised of a mammal pest barrier resistant to mammal pest passage therethrough. The bag is sized and shaped to receive a ground vehicle, such as an automobile, a truck, a recreational vehicle, farming equipment, construction equipment or the like. Included is establishing access to an interior surface of the bag; by way of this access, moving the ground vehicle into the bag to rest on the interior surface thereof; and while the ground vehicle is resting on the interior surface, closing the bag to envelop the ground vehicle inside the bag and isolate the ground vehicle from mammal pests outside of the bag. In one form, the closure of the bag is provided with a type of zipper.

### FIELD

The present application relates generally to pest protection; and more particularly, but not exclusively relates to: techniques, systems, methods, processes, apparatus, and devices directed to a pliable, re-closeable rodent shield for a recreational vehicle.

### BACKGROUND

Protection of vehicles from pests has been an age-old problem—especially for vehicles typically kept outdoors, such as Recreational Vehicles (RVs) or the like. Rodents can be a particularly difficult problem because they readily gnaw, bite, claw, paw, scratch, bite, tunnel, dig, or chew through a wide variety of materials to get to food stuffs stored in RVs and even will diligently pursue food scraps, crumbs or trash. Unfortunately, typical packaging and many other food-enclosing materials can be easily penetrated by rodents, and the vehicle itself usually offers little protection.

One scheme to address such difficulties is to apply rodent poison and/or traps; however, such schemes often pose safety concerns and/or health hazards—including the unpleasant prospect of disposing of resulting rodent carcasses. Other schemes might partially cover the vehicle (especially the top and sides), but leave gaps, slots, and other openings through which pests may pass. Still other make-shift schemes attempt to plug-up rodent access openings into the vehicle or otherwise provide a hole/gap-closing shield to discourage rodent entry, but such approaches are often imperfect and do not address the rodent's ability to create new openings through a variety of vehicle covering materials by chewing, biting, pawing, digging, tunneling, gnawing, scratching, clawing, or the like. Current schemes also can be cumbersome to use, and may make it difficult to readily and consistently obtain a satisfactory result in certain instances. Accordingly, there remains an ongoing demand for further contributions in these technical arenas.

### SUMMARY

By way of transition from the background to the summary/detailed description of the inventions of the present application, one or more specific definitions, and any sub-definitions thereof, are set forth below and supplemented by example or further explanation, as appropriate. These definitions are provided to: (a) resolve meaning sometimes potentially subject to ambiguity in the applicable technical field(s) and/or (b) exercise the right of an inventor to be a lexicographer where deemed appropriate):
1. “Ground vehicle” broadly refers to each of the following sub-definitions, explanations, examples, and listings—(a) Motorized, On-road: any motorized vehicle primarily operating on-road with three or more road-engaging wheels (including: an automobile, a bus, a pick-up truck, a minivan, a station wagon, a Sport Utility Vehicle (SUV), a passenger van, a three-wheeled ELIO or POLARIS cars, or the like); (b) Recreational Vehicle (RV): any motorized vehicle with four or more road engaging wheels primarily serving recreational travel purposes (including: a motor coach, a truck camper, a camping van/bus, or the like) or any trailer with at least two road engaging wheels primarily serving recreational travel purposes (including: a watercraft-carrying trailer, an ATV-carrying trailer, a motorcycle-carrying trailer, a camping trailer (pop-up camper, fifth wheel, or the like)); (c) Cargo/hauling, On-Road: Cargo-hauling/Delivery: any on-road, motorized vehicle with four or more road engaging wheels or trailer with at least two road engaging wheels for receiving, delivering, and/or hauling bulk or non-bulk cargo, or service delivery (including: a delivery van or truck, a service van or truck for towing, repair, food service, lawn/tree care, or the like), a cargo van, a cargo truck, a cargo-hauling trailer, a tractor trailer (so called “18 wheeler” (including a hard or soft-sided trailer that may carry separately packaged, differently sized cargo), a flatbed tractor-trailer, a bulk material liquid/fluid-carrying tanker truck, and a bulk dry material carrying trailer/truck (such as the covered grain hauling type)); an animal transport trailer; refrigeration truck, or the like; (d) Farming/Agricultural: any farming/agricultural equipment having at least two ground-engaging wheels that holds at least one occupant and/or conditions or aerates soil; ploughs, hauls, collects, carries, cuts, bails, harvests, plants, seeds and/or distributes farming material, agricultural material or farming implements (including, but not limited to: animal byproduct, animal feed, biocide, fertilizer or other soil amendment, a harvested crop, harvest collection containers, one or more animals, planting seed, seedlings, or saplings) (including: a farming tractor, a wagon, a combine, harrow, cultivator, movable irrigation equipment, sprayer, a bush hog, a lawn mower, a planter, a harvester, a suitable flatbed truck, or the like); or (e) Other off-road: any other off-road vehicle with two or more ground-engaging wheels, that holds at least one occupant.
2. “Inorganic” (versus carbon and organic) means generally any substance or compound lacking carbon-hydrogen covalent bonds, excluding any substance or compound widely recognized as an organic substance or compound (there is some dispute/ambiguity recognized here), but, to dispel any doubt, is inclusive of pure carbon and its allotropes (such as amorphous carbon, carbyne (linear acetylenic carbon), carbon nanofoam, diamond, fullerenes, glassy carbon, graphite, graphene, or the like), and various carbon-bearing compounds widely recognized as being inorganic (such as carbon monoxide, carbon dioxide, carbonates, cyanides, cyanates, carbides, thiocyanates, or the like).
3. “Mammal pest” means one or more of: rodents (including, but not limited to: rats, mice, woodchucks, tree squirrels, ground squirrels, marmots, and chipmunks); moles; shrews; opossums; bats; skunks; and raccoons.
4. “Elemental metal” means any metal with a unique position in the periodic table that is in its pure, uncompounded, unalloyed atomic form except it may include some minor impurities. There are approximately 90 elemental metals, although at times some elements may resemble an elemental metal and a metalloid and/or nonmetal lending some ambiguity to the meaning (for example, aluminum may be regarded as a metal and a metalloid under varying circumstances as further defined below).
5. “Alloy” means a compound comprised of a combination of two or more different elemental metals, a combination of at least one elemental metal and at least one metalloid (such as: antimony, arsenic, astatine, boron, carbon, germanium, polonium, selenium, silicon, tellurium), or any of these combinations with minor impurities. Given there is some ambiguity as to what constitutes a metalloid versus a metal or nonmetal, this metalloid listing errs on the side of over-inclusion; however, to dispel any doubt, aluminum is considered both a metal and a metalloid for the purposes of the present application.
6. “Metal” refers broadly to both an elemental metal and an alloy.
7. “Metallic” means any substance with metal properties, or a compound comprised of at least one metal atom combined with one or more nonmetal atoms, including, but not limited to: inorganic compounds with at least one atom of metal (including, but not limited to, as metal oxides) and organic compounds including at least one atom of metal (including but not limited to, organometallics).
8. “Poly-aramid fiber” means a synthetic organic polymer fiber that collectively refers to any para-aramid synthetic organic polymer, any meta-aramid synthetic organic polymer, and any combination thereof (if any); where para-aramid includes, but is not limited to, Poly(p-phenylene terephthalamide) (PPTA), (PPTA being a more specific form of para-aramid and both known by the DUPONT trademark KEVLAR) and meta-aramid synthetic fiber includes, but is not limited to, Poly(m-phenylene terephthalamide) (PMIA), (PMIA being a more specific form of meta-aramid and both known by the DUPONT trademark NOMEX).
   The above listing of one or more definitions/sub-definitions apply to any reference to the corresponding terminology herein unless explicitly set forth to the contrary. All acronyms, abbreviations, and terms parenthetically defined herein apply to the same extent.

Among the embodiments of the present application are unique techniques to manage pest encroachment. Other embodiments include unique devices, apparatus, methods, processes and systems to provide a pest barrier enclosing a ground vehicle.

Another embodiment is directed to a method, comprising: providing a pliable bag comprised of a pest barrier material resistant to pest passage therethrough; establishing access to an interior surface of the bag; by way of the access, moving a ground vehicle to rest on the interior surface with the bag being positioned under wheels of the ground vehicle; and closing at least one zipper to enclose the ground vehicle inside the bag while at rest therein to isolate the ground vehicle from pests external to the bag.

Still another embodiment comprises: employing an enclosure comprised of a pliable mammal pest barrier resistant to mammal pest passage therethrough, the enclosure including a base defining a base margin and an envelope defining an envelope margin; moving a ground vehicle to rest on the base with the base margin at least partially surrounding the ground vehicle and the envelope positioned out from under the base and the ground vehicle, covering the ground vehicle on the base with the envelope to position the base and the envelope approximately opposite each other and to bring together the base margin and the envelope margin; and joining the base margin and the envelope margin to envelop the ground vehicle inside the enclosure and isolate the ground vehicle from mammal pests outside the enclosure. In one nonlimiting refinement of this embodiment, the base margin and the envelope margin are joined by a two-way closed-end zipper configuration including base zipper teeth, envelope zipper teeth, a first zipper stop, a second zipper stop, and at least one slider to open and close the enclosure.

Yet another embodiment includes: arranging an enclosure to prepare for ground vehicle engagement therewith, the enclosure comprised of a pliable pest barrier material resistant to pest passage therethrough, the enclosure including two or more enveloping portions, a first one of the enveloping portions defining a first margin and a second one of the enveloping portions defining a second margin; after arranging the enclosure, engaging the enclosure with a ground vehicle, including placement of a ground vehicle in contact with an interior of one or more of the enveloping portions; and enclosing the ground vehicle with the enveloping portions, including connecting the first margin and the second margin together with a fastener operable to open and close an opening between the first margin and the second margin, the fastener cooperating with the barrier material to isolate the ground vehicle inside the enclosure and keep pests outside the enclosure. In a further nonlimiting refinement of this embodiment: the enveloping portions are connected together with a zipper, the first one of the enveloping portions defines a base, the engaging of the enclosure includes moving the ground vehicle onto the base to position different portions of the enclosure under a number of different wheels of the ground vehicle, the fastener includes a first row of zipper teeth along the first margin and a second row of zipper teeth along the second margin, and the connecting of the first margin and the second margin together includes meshing the first row of zipper teeth and the second row of zipper teeth to define a zipper chain of the fastener closing the opening, and the fastener is a two-way closed-end zipper configuration including at least one zipper slider,

A further embodiment of the application includes: providing a pliable bag comprised of a mammal pest barrier, the barrier being resistant to mammal pest passage therethrough, the bag being sized and shaped to receive a ground vehicle; establishing access to an interior surface of the bag; by way of the access, moving the ground vehicle into the bag to rest on the interior surface thereof; and while the ground vehicle is resting on the interior surface, closing the bag to envelop the ground vehicle inside the bag and isolate the ground vehicle from mammal pests outside of the bag. In one nonlimiting form of this embodiment, the closed zipper is of a two-way closed-end zipper configuration including a first zipper stop, a second zipper stop, and at least one zipper slider.

Still a further embodiment includes: a pliable bag comprised of a mammal pest barrier that includes means for composing the pest barrier to be resistant to passage therethrough by chewing, biting, gnawing, clawing, pawing, digging, scratching, and tunneling of rodents (and optionally other mammal pests). The bag is sized and shaped to receive a ground vehicle. This embodiment further includes means for establishing access to an interior surface of the bag, means for moving the ground vehicle into the bag to rest on the interior surface thereof by way of such access, means for closing the bag, means for enveloping the ground vehicle inside the bag, and means for isolating the ground vehicle from rodents (and optionally other mammal pests) outside of the bag while the ground vehicle is resting on the interior surface.

Yet a further embodiment includes: an enclosure comprised of a pliable pest barrier material resistant to pest passage therethrough, means for arranging the enclosure to prepare for ground vehicle engagement therewith. In one form, the enclosure has two or more enveloping portions, a first one of the enveloping portions defining a first margin and a second one of the enveloping portions defining a second margin. This embodiment further includes: means for engaging the enclosure with a ground vehicle after the arranging of the enclosure, means for placing the ground vehicle in contact one or more of the enveloping portions, means for enclosing the ground vehicle with the enveloping portions, means for connecting the first margin and the second margin together to open and close an opening between the first margin and the second margin, the means for connecting and the barrier material cooperating to isolate the ground vehicle inside the enclosure and keep pests outside the enclosure.

Another embodiment comprises: an enclosure comprised of a pliable mammal pest barrier resistant to mammal pest passage therethrough, the enclosure including a base defining a base margin and an envelope defining an envelope margin; a ground vehicle resting on the base with means for at least partially surrounding the ground vehicle with the base margin and means for positioning the envelope out from under the base and the ground vehicle; means for covering the ground vehicle on the base, means for positioning the base and the envelope approximately opposite each other and means for bringing together the base margin and the envelope margin; and means for joining the base margin and the envelope margin to envelop the ground vehicle inside the enclosure and isolate the ground vehicle from mammal pests outside the enclosure.

Other additions, advantages, alterations, apparatus, applications, aspects, benefits, changes, components, compositions, constituents, devices, embodiments, equivalents, features, forms, implementations, materials, methods, modifications, objects, operations, options, processes, refinements, structures, substitutions, subtractions, systems, techniques, and variations shall become apparent from the written description and any drawing(s) provided herewith.

### BRIEF DESCRIPTION OF THE DRAWING(S)

Throughout the following figures, like reference numerals and characters earlier introduced refer to like features previously described therewith.

FIG. 1 is a partially diagrammatic, top plan view of an opened vehicle enclosure made from a pest barrier material.

FIG. 2 is a partially diagrammatic, elevational side view of a ground vehicle resting on a base of the enclosure.

FIG. 3 is a partially diagrammatic, elevational rear view of the ground vehicle resting on the base that corresponds to the 3-3 view line shown in FIG. 2.

FIG. 4 is a partially diagrammatic, elevational side view of the ground vehicle resting on the base with the top cover partially installed thereover. The ground vehicle is shown in phantom to the extent it is covered by the enclosure.

FIG. 5 is a partially diagrammatic, elevational side view of the enclosure completely enveloping the ground vehicle with the ground vehicle shown in phantom.

FIG. 6 is a partially diagrammatic, elevational front view of the enclosure completely enveloping the ground vehicle shown in phantom that corresponds to the view line 6-6 shown in FIG. 5.

FIG. 7 is a partially diagrammatic, elevational rear view of the enclosure completely enveloping the ground vehicle shown in phantom that corresponds to the view line 7-7 shown in FIG. 5.

FIG. 8 is a partially diagrammatic cutaway, cross-section of a pest-resistant barrier in the form of a lamination of two or more lamina.

### DETAILED DESCRIPTION OF REPRESENTATIVE EMBODIMENTS

In the following description, numerous specific details are given to provide a thorough understanding of various representative embodiments of the present application. One skilled in the relevant art shall recognize, however, that any inventions of the present application can be practiced without one or more of the specific details, or with other additions, advantages, alterations, apparatus, applications, aspects, benefits, changes, components, compositions, constituents, devices, embodiments, equivalents, features, forms, implementations, materials, methods, modifications, objects, operations, options, processes, refinements, structures, substitutions, subtractions, systems, techniques, variations, or the like. In other instances, well-known aspects are not shown or described in detail to avoid obscuring innovative characteristics. Thus, for the purposes of promoting an understanding of the principles of any inventions set forth herein, reference shall now be made to representative embodiments, any drawing(s), and specific language shall be used to describe the same. It shall nevertheless be understood that no limitation of the scope of any inventions are intended thereby. From the written description and any drawing(s) provided herein, it shall also become apparent that other additions, advantages, alterations, apparatus, applications, aspects, benefits, changes, components, compositions, constituents, devices, embodiments, equivalents, features, forms, implementations, materials, methods, modifications, objects, operations, options, processes, refinements, structures, substitutions, subtractions, systems, techniques, and variations, may also be realized without departing from the scope of any inventions set forth herein or in any of the claims listed hereafter.

One nonlimiting embodiment of the present application is a unique technique to envelope a ground vehicle with an enclosure comprised of a pest barrier material. The enclosure includes a first enveloping portion opposite a second enveloping portion that are joinable together by a zipper. A ground vehicle is placed on an interior surface of the first enveloping portion and the second enveloping portion is placed over the ground vehicle to be positioned opposite the first enveloping portion to align them for closure by the zipper.

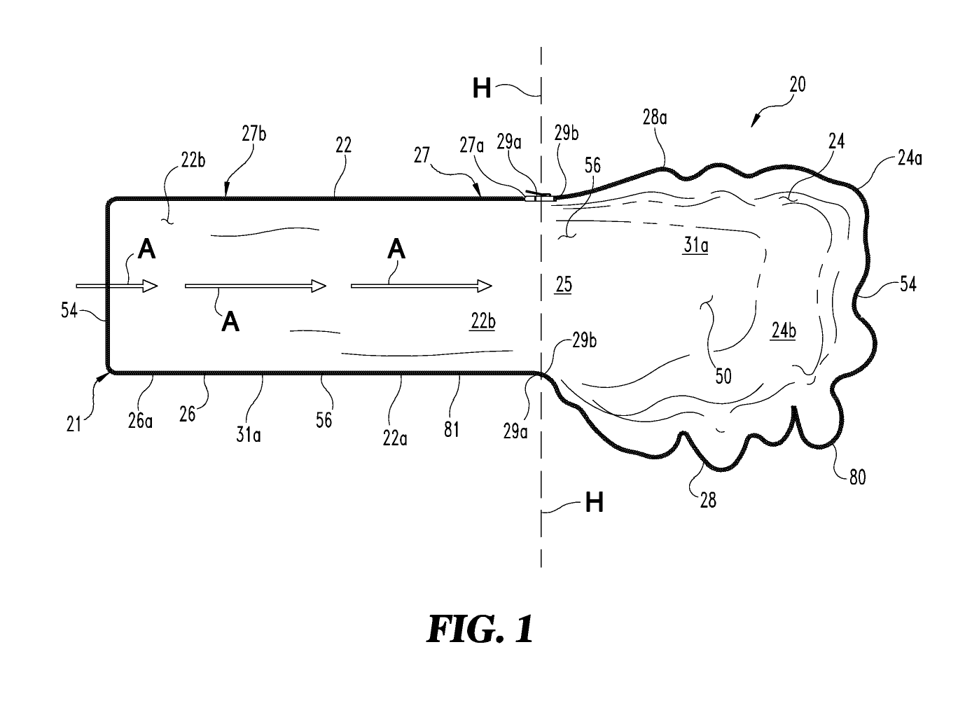

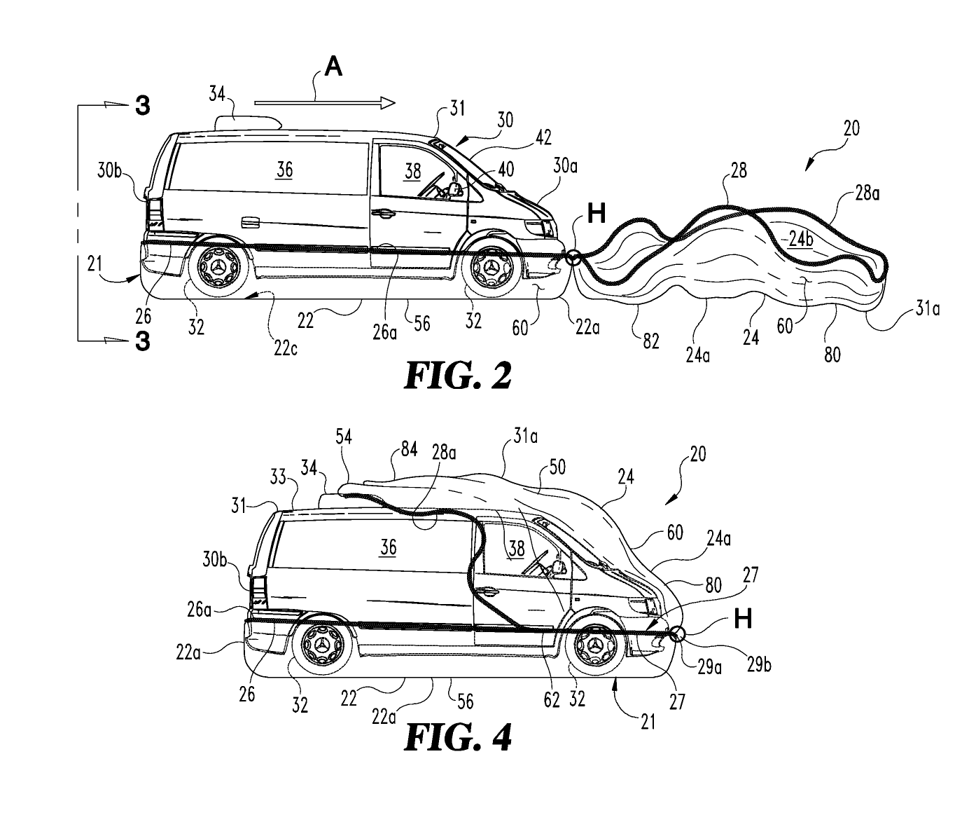

FIG. 1 depicts vehicle pest protection enclosure system 20 of a further embodiment of the present application. System 20 includes pest-resistant enclosure 21 with two opposing enveloping portions 22 and 24. Portions 22 and 24 are connected together by region 25 that provides for a “clamshell” type of closure of portions 22 and 24 by pivoting relative to axis H through region 25, as further described in connection with FIGS. 2-7. Collectively portions 22 and 24 are configured to define a form of closable, pest-resistant bag 80 that is shown in an unassembled configuration 81 in FIG. 1. Enclosure 21/bag 80 is made of a pliable/flexible, pest-resistant barrier 31a that may take on any of a number of different forms and/or compositions depending on the type of pest to be resisted as further described hereinafter. Configuration 81 is a form of enclosure 21/bag 80 that is spread-out to prepare for use with a vehicle—typically being in a more compact storage configuration when not being prepared for or in use (not shown). Indeed, enclosure 21/bag 80 may be stored in its own bag or stuff sack.

Portion 22 is configured as ground-engaging base 22a with interior surface 22b and portion 24 is further configured as a covering, above-ground upper envelope 24a with interior surface 24b. Upper envelope 24a is shown in a bunched-up, folded arrangement in configuration 81 and further is not placed under or on base 22a in in configuration 81 of FIG. 1. Base 22a defines margin 26 and envelope 24a defines margin 28. Margin 26 terminates in a row of zipper teeth 26a and margin 28 terminates in a row of zipper teeth 28a configured to intermesh with zipper teeth 26a. Each row of zipper teeth 26a and 28a extends from a first zipper end stop 29a to a second zipper end stop 29b. Zipper end stops 29a and 29b of each row of zipper teeth 26a and 28a are positioned generally opposite each other with region 25 extending therebetween along axis H. Zipper slider body and pull configuration 27a rides along zipper teeth 26a and 28a to selectively mesh them together or separate them in a standard manner. Collectively, zipper teeth 26a, 28a; zipper end stops 29a, 29b; and slider body and pull configuration 27a define zipper 27 of the two-way closed end type 27b. Such type 27b is common to various soft-sided luggage zippered closures, for instance.

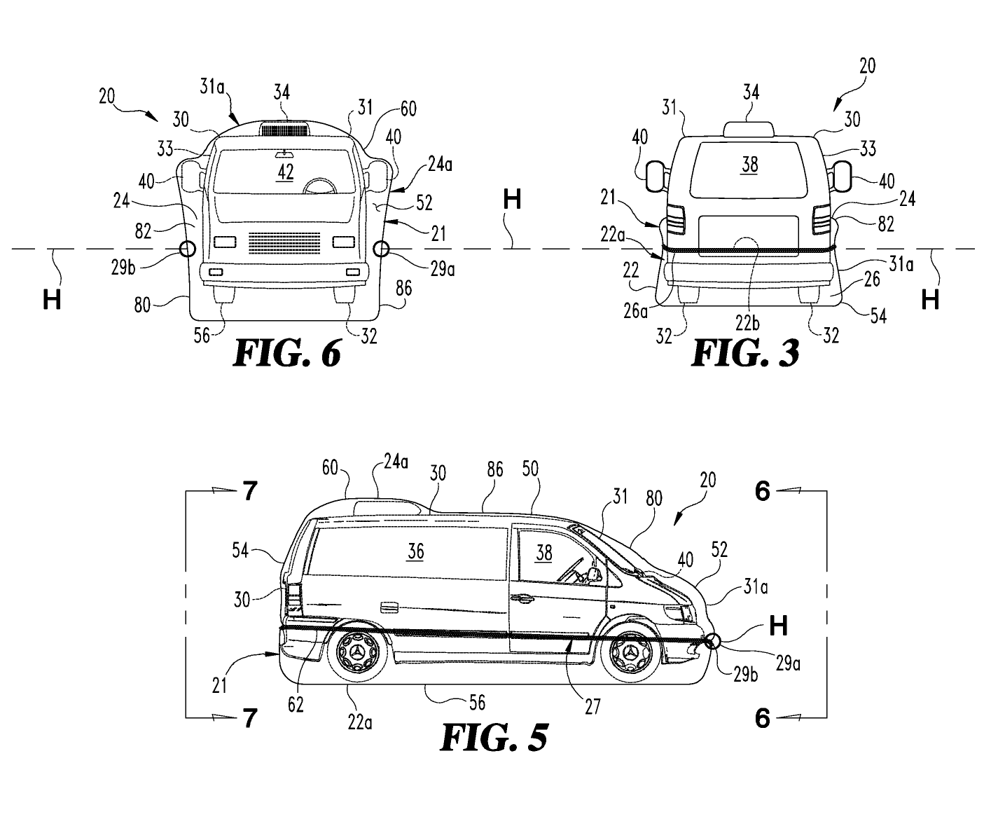

As best shown in FIGS. 2 and 3, system 20 is illustrated in a vehicle-engaged configuration 82 in which ground vehicle 30 is seated on interior surface 22b of base 22a, resting thereon, and is partially enveloped by base 22a that is in a more progressive stage of assembly compared to unassembled configuration 81 of FIG. 1. Base 22a and correspondingly different portions of interior surface 22b are positioned under different wheels 32 of vehicle 30. The rear view of FIG. 3 corresponds to the view line shown in the side view of FIG. 2. It should be appreciated that vehicle 30 is positioned over interior surface 22b to define a vehicle footprint 22c in correspondence to the portion of surface 22b directly under vehicle 30. Footprint 22c is surrounded by a portion of interior surface 22b positioned between footprint 22c and margin 26. To the extent covered by enclosure 21, vehicle 30 is shown in phantom. Vehicle 30 includes body 31 with front end body portion 30a opposite rear end body portion 30b, and is further depicted in the form of an RV motor coach 33. Vehicle 30 includes side and rear windows 36 and 38 with windshield 42. Vehicle 30 further includes air conditioning unit 34, and opposing side rear-view mirrors 40.

Referring additionally to FIG. 4, assembly progression from configuration 82 of FIGS. 2 and 3 to partially assembled/zipped configuration 84 is illustrated. In configuration 84, front covering portion 52 of barrier 31a has been placed over front end body portion 30a of vehicle 30 and top covering portion 50 of barrier 31a has been partially placed over vehicle 30. Base 22a comprises lower covering portion 56 of barrier 31a, while rear covering portion 54 of barrier 31 remains bunched up on the top of and along the sides of vehicle 30. In configuration 84, zipper 27 is in an intermediate position corresponding to the partial assembly of enclosure 21 about vehicle 30. Exterior surface 60 of enclosure 21 is also illustrated as upper envelope 24a becomes unfolded, un-bunched, and “un-crumpled” in configuration 84. The covered part of vehicle 30 is shown in phantom in FIG. 4.

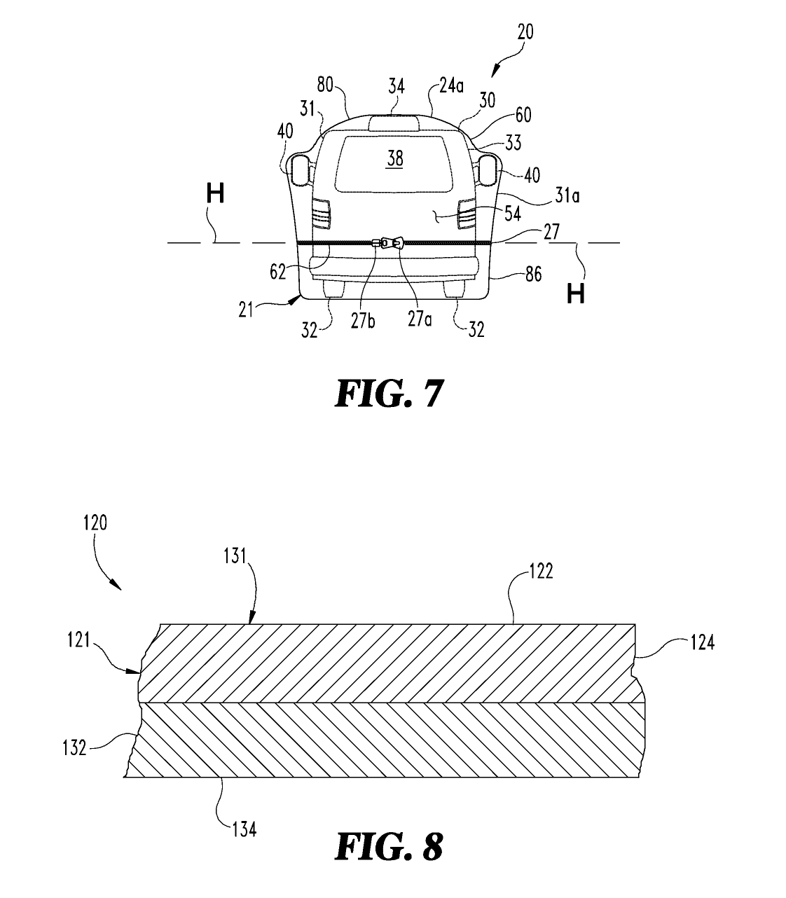

Referring additionally to FIGS. 5-7, a fully assembled enclosure configuration 86 is illustrated with zipper 27 fully closed—showing side, front, and back views, respectively, with vehicle 30 in phantom. FIGS. 6 and 7 correspond to the view lines shown in association with FIG. 5. In configuration 86, fully closed zipper 27 and barrier 31a cooperate to seal vehicle 30 inside of enclosure 21—isolating vehicle 30 from pest—depending on the extent to which barrier 31a resists penetration by a given pest type. Indeed, in some embodiments, barrier 31a is effective to resist penetration by mammal pests (inclusive of rodents), while in other embodiments, barrier 31a is effective to resist penetration by rodents only. In still other embodiments, barrier 31a is effective to resist penetration by only a subset of rodents, namely mice and rats.

For rodent-type of pests, it has been found that a fine metal screen, mesh, hardware cloth, or other fabric composed of a metal, such as galvanized or stainless steel, provides a highly rodent resistant barrier, while remaining pliable and flexible enough to operate as barrier 31a comprising enclosure 21 in FIGS. 1-7. Steel coated wool (such as stainless steel or galvanized steel) incorporated in an effective mesh or fabric can provide for rodent-resistance, too. Certain high-strength synthetic organic polymer-based fibers and fabric, with or without an elemental metal, alloy, and/or metallic coating of the fibers would be capable of providing at least some degree of rodent resistance—particularly in combination with other materials, such as in a pliable, resin-based composite or arranged in a pliable fabric with or without other materials. Still another arrangement includes a matrix of finely spaced-art, small dots or other pieces of a ceramic or ceramic-glass attached to a flexible backing to provide desired pliability/flexibility. Yet another arrangement includes fibers in a mesh or fabric configuration comprised of glass, ceramic, ceramic glass, carbon, or another suitable inorganic material. These arrangements would also provide at least some resistance to penetration by non-rodent mammal pests.

The above arrangements provide for mammal pest resistance to penetration, but may be gas and/or liquid permeable. Correspondingly, smaller pests, such as “bugs”—insects, arachnids, larvae, or the like may still be able to readily penetrate at least some of these compositional/mechanical arrangements. To be resistant to smaller pests and/or water resistant, a dense fabric or coating composed of a material suitable to smaller pest resistance may be laminated together with a gas and/or liquid permeable arrangement to also be resistant to mammal pests. In still other embodiments a suitably comprised fabric or composite material with the requisite flexibility/pliability provides resistance to mammal pests and smaller pests with or without liquid resistance. In one such composite, metal wire fibers are tightly woven into a fabric otherwise composed of water-resistant polymeric fibers—just to name one example.

FIG. 8 provides a partial diagrammatic cutaway, cross-section of lamination 120 that may be used to make a sufficiently pliable barrier 31a. More specifically designated as pest barrier 131. Lamination 120 includes laminae 121 comprising outer lamina 122 or layer 124 attached/laminated to inner lamina 132 or layer 134. In one embodiment, outer lamina 122 is comprised of a metal mesh, hardware cloth, or fabric that has desired mammal resistance, but may not necessarily have desired liquid resistance; however, attached to such form of lamina 122 is lamina 132 made of a water-resistant fabric or nonfabric layer of a high strength thermoplastic that also offers some resistance to smaller insect/arachnid pests. In another embodiment, one or more of laminae 121 includes a thermoplastic coating applied to a fabric or other backing sufficient to collectively provide the desired degree of pliability/flexibility, pest resistance, gas permeability (to allow enclosure 21 to “breathe”), and/or water resistance. Such arrangement may include more than two laminae 121 in some embodiments (not shown). In a further embodiment, at least one of lamina 121 is a polymeric resin and fiber composite sheet or film. In still other embodiments, barrier 31a/barrier 131 may not be composed of a multilayer lamination 120; instead being a single layer of a composite, fabric, sheet, film, or mesh.

One preferred embodiment of the present application includes a pest barrier comprised of inorganic fibers. Another preferred embodiment includes such barrier comprising one or more of: metallic fibers, metal fibers, metal-coated wool, a polymer-coated metal mesh, hardware cloth, metallic mesh, metal mesh, metal screen, metallic screen, metal fabric, metallic fabric, and metal-coated and/or metallic-coated synthetic organic polymeric fiber or fabric thereof; or resin composite of any of these.

A further preferred embodiment includes pest barrier comprised of one or more of: an inorganic substance and synthetic organic polymer fiber structured and composed to resist biting, chewing, gnawing, tunneling, digging, scratching, clawing, and pawing by pests (including mammal pests, such as rodents or the like). A more preferred embodiment of pest barrier is an arrangement of fibers comprised of: metal; metal oxide; a metal-coated wool, such as steel wool, stainless steel wool, galvanized steel wool; carbon; ceramic; ceramic-glass; glass; para-aramid synthetic fiber; meta-aramid synthetic fiber; Ultra-High-Molecular-Weight PolyEthylene (UHMWPE) (also known as UHMW, High-Modulus PolyEthylene (HMPE), and High-Performance PolyEthylene (HPPE)—with certain fiber forms of UHMWPE also known by the trademarks DYNEEMA and SPECTRA); poly-aramid fiber and/or UHMWPE with or without elemental metal, alloy, metal, or metallic-coating; analogs thereof; fabrics thereof; and polymeric resin composites comprised thereof. An even more preferred embodiment of pest barrier includes the pest barrier comprised of one or more of PPTA, PMIA, UHMWPE, any combination of these, any analogs thereof, any fabrics thereof, and any resin composites thereof. Still another even more favored embodiment of barrier 31a includes one or more of: elemental metal, alloy, metal, or metallic-coated PPTA fiber; PMIA fiber, UHMWPE fiber, any combination of these, analogs thereof, any fabrics thereof, and any resin composites thereof.

Still another preferred embodiment includes a pest barrier comprised of at least one of a gas permeable: hardware cloth; stainless steel wool cloth; elemental metal, alloy, metal, or metallic fibers structured as one or more of a knit, woven and knotted fabric with a pattern of small openings; PolyVinylChloride (PVC) coated wire mesh; and a blend of stainless steel wool interwoven with polymer fibers (also known under the trademark XCLUDER). A more preferred form including a gas permeable arrangement of a pest barrier comprises one or more of: fabric comprised of inorganic fibers, fabric comprised of organic polymer fibers, hardware cloth; steel wool; stainless steel wool cloth; galvanized steel wool; elemental metal, allow, metal or metallic fibers; PVC coated wire mesh; a blend of stainless steel wool interwoven with polymer fibers; metal oxide fiber; carbon fiber; ceramic; ceramic-glass; glass fiber; elemental metal, alloy, metal, or metallic-coated poly-aramid polymer and/or UHMWPE; analogs thereof; fabrics thereof; and polymeric resin composites comprised thereof.

Yet another preferred embodiment comprises a pest barrier comprised of at least one of an inorganic substance and a synthetic organic polymer, in which: the inorganic substance comprises one or more of: metal fiber, metal-coated fiber, ceramic, ceramic-glass, carbon fiber, and inorganic oxide; fabrics comprised thereof, analogs thereof, and composites thereof; and the synthetic organic polymer comprises one or more of: para-aramid, meta-aramid, and UHMWPE fibers; metal-coated forms thereof, fabric comprised thereof; analogs thereof, and composites thereof. In a more preferred form thereof: (a) the metal fiber comprises one or more of: metal fabric; hardware cloth; metal mesh, and metal screen; and PVC-coated metal; (b) the metal-coated fiber comprises one or more of: steel wool, stainless steel wool, galvanized steel wool; entangled stainless steel wool and polymeric fibers; analogs thereof; fabrics thereof; and polymeric resin composites thereof; (c) the ceramic and ceramic-glass comprises one or more of: spaced apart ceramic pieces laminated on a water-resistant nylon, poly-aramid, polybenzimidazole (PBI); polyethylene (generally “PE”—a family of similar materials categorized according to their density and molecular structure, as follows: UHMWPE, High-density polyethylene (HDPE), Medium-density polyethylene (MDPE), Low-density polyethylene (LDPE), XLPE or “PEX” (cross-linked polyethylene) which is a semi-rigid/flexible material); polyester (a family that typically includes the ester functional group in the main polymer chain that most commonly refers to polyethylene terephthalate (PET)); polypropylene (PP); and polyvinylchloride (PVC); ceramic fibers; ceramic-glass fibers;, elemental metal, alloy, metal, or metallic coating thereof; fabrics thereof, and polymeric resin composites thereof; (d) the carbon fiber comprises one or more of: analogs thereof, carbon fiber fabrics thereof, and polymeric resin composites thereof; and (e) the inorganic oxide comprises one or more of: glass and metal oxide; fibers and fabrics thereof; and polymeric resin composites thereof.

In a further preferred form the barrier material is comprised of a lamination including multiple laminae in which: a first one of the laminae is comprised of one or more of: metal fibers, metal-coated fibers, ceramic fibers, ceramic-glass fibers, carbon fibers, inorganic oxide fibers; para-aramid, meta-aramid, and UHMWPE fibers; fabric thereof; mesh thereof; screen thereof; polymeric resin composite thereof; spaced-apart ceramic pieces; and spaced-apart ceramic-glass pieces; and a second one of the laminae is comprised of one or more of a water resistant: fabric, thermoplastic polymer layer, thermoset polymer layer, and a composite including a polymeric resin and one or more of: inorganic fibers, para-aramid fibers, meta-aramid fibers, and UHMWPE fibers.

A further preferred form including a pest-resistant barrier that comprises a lamination comprised of two or more laminae, the laminae including a first lamina and a second lamina composed in accordance with one of (a) through (d) as follows:

(a) the first lamina including a pattern of ceramic pieces and the second lamina including a water-resistant synthetic organic polymer suitable for configuration as a suitable pliable fabric, resin composite, or sheet of material, including but not limited to: nylon; PBI; PE including UHMWPE, HDPE, MDPE, LDPE, XLPE, or PEX; polyester; PET; PP; and PVC; and analogs thereof.

(b) the first lamina including one or more of: a liquid permeable arrangement of inorganic fibers, a liquid permeable arrangement of thermoplastic fibers, and a liquid permeable arrangement of thermoset fibers; and the second lamina including at least one of a water resistant: fabric, thermoplastic polymer film, thermoset polymer film, thermoplastic polymer sheet, thermoset polymer sheet, thermoplastic polymer coating, and thermoset polymer coating;

(c) the first lamina including a composite of inorganic fibers and a polymeric resin and the second lamina being one or more of: a thermoplastic polymer layer and a thermoset polymer layer; and

(d) the first lamina including one or more of: steel wool, stainless steel wool, and galvanized steel wool; metal oxide; carbon fiber; carbon fabric; ceramic; ceramic-glass; glass; para-aramid synthetic fiber; meta-aramid synthetic fiber; UHMWPE; metal fiber structured as one or more of a knit, woven, and knotted fabric with a pattern of openings; metal wire structured as one or more of: a hardware cloth, a mesh and a screen; and the second lamina including one or more of a: pliable fabric, thermoplastic polymer layer/sheet, thermoset polymer layer/sheet, and a composite of fibers and a polymeric resin.

Other preferred embodiments include any of the following claims hereinafter that includes a barrier composition listing to the extent such listing varies from that described hereinbefore.

To disassemble configuration 86 of enclosure 21, reverse the progressive stages shown in FIGS. 1-7, from fully assembled configuration 86 of FIGS. 5-7 to partially assembled configuration 84 of FIG. 4 by starting to and partially unzipping zipper 27. Continuing with disassembly, zipper 27 is fully unzipped to arrive at configuration 82 of FIGS. 2 and 3. Vehicle 30 can then be removed from base 22a to arrive at configuration 81 of FIG. 1. Enclosure 21 may then be folded-up and stored.

Any theory, thesis, hypothesis, mechanism of operation, proof, example, speculation, or finding stated herein is meant to further enhance understanding of one or more of the claimed inventions and is not intended to make any claimed invention in any way dependent upon, limited by, or otherwise subject to such theory, thesis, hypothesis, mechanism of operation, proof, example, speculation, and/or finding. Furthermore, reference throughout the present application to “embodiment” (with or without any modifiers) means that one or more particular aspects described in connection with the same are included in at least one embodiment, but may be included in one or more other embodiments. Multiple references to “embodiment” herein (with or without any modifiers) are not necessarily all referring to the same embodiment. For avoidance of doubt, all language of any claims that follow shall be interpreted to be of the “open” type unless explicitly limited by one or more of the following and then only to the extent expressly limited thereby: (a) a “closed” transition (consists of, consist of, or consisting of), (b) a “partially closed” transition (consisting essentially of, consist essentially of, or consists essentially of), or (c) to the extent subject to a negative modifier or conjunction (alone, but, exclusive(ly), integral(ly), just, neither, no, not, none, nor, only, single, solely, unitary, without, and whereby); negation by suffix (-less); or negation by prefix (de-, dis-, it-, in-, im-, it-, mis-, non-, or un-). It should be understood that any use of the words: important, critical, crucial, significant, essential, salient, imperative, substantial, extraordinary, favor, favored, favorably, favorable, desire, desired, desirable, desirably, prefer, preferable, preferably, preference, and preferred as modifiers in the description indicates that the feature so described may be desirable, and further may be used to indicate different degrees of desirability among different features, listings, ranges, or the like; however, any such feature(s), listing(s), range(s), or the like shall not to be incorporated or otherwise required in any of the claims set forth hereinafter unless expressly described therein and further does not preclude the existence of embodiments and/or claimed inventions of the present application lacking the same.

For any method or process claim included herein, the recited acts, actions, advancements, clauses, conditions, conjunctive terminology (at which, by what/which, because, however, provided that, so, so that, whereat, wherein, whereby, wherefrom, whereinto, whereof, whereon, whereto, from which/whence, to which, in which, into which, in what, on what/which, of what/which/whom, and, or, but, whereas, yet, if, or the like—just to name a few), contingencies, deeds, degrees, elements, equalities, formulae, gerunds, grades, inequalities, levels, limits, means, operations, phases, procedures, proceedings, progressions, points, ranges, routines, stages, steps, or the like (collectively a nonexclusive listing of various “method claim features”) do not necessarily need to be performed in a particular order or sequence (including that of the written order/sequence of the method claim features or other claim listing) in order to be infringed. There is no intention that method claim scope (including sequence/order) be limited, restricted, confined or otherwise influenced because: (a) the method/process claim as written just happens to recite one method claim feature before another; (b) an indefinite article is used with a method claim feature when first introduced and a definite article thereafter to conform to formalistic “definiteness” requirements that are generally independent of applicable claim construction considerations, or (c) the claim includes labeling for organizational purposes, such as: numerical labeling (with cardinal numbers) in ascending, descending, or other order; letter labeling in alphabetical, reverse alphabetical, or other order; or other labeling characters. To the extent there is an intention to limit the method claim scope to a particular order or sequence, ordinal numbers (1^{st}, 2^{nd}, 3^{rd}, and so on) or corresponding words (first, second, third, and so on) shall be expressly used and denoted to specify the drafter's intended order/sequence—subject to various evolving claim construction exceptions that may, at least to some extent, otherwise impose a given order/sequence in the absence of a specific express ordering. Further, to the extent claim construction requires one method claim feature before another, such ordering as to these two method claim features should alone serve as a basis to impose an order on any other method claim features occurring listed before or after these features or intervening therebetween.

There is no intent that a claimed feature be interpreted as a means or step for performing a specified function unless expressly introduced and accompanied by recitation of the language “means for” or “step for” respectively (collectively designated “means plus function” language). Typically, means plus function language is used, if at all, in one or more dependent claims to differentiate language in other claims lacking such specific expressions. As used herein, “portion” means a part of the whole, broadly including both the state of being separate from the whole and the state of being integrated/integral/contiguous with the whole, unless expressly stated to the contrary. Representative embodiments have been provided in detail in the foregoing description potentially under various headings or subheadings; however, the same are for convenience only and do not define, limit, or otherwise indicate the scope or meaning of any embodiments, inventions, or description set forth herein, including any claims that follow. While representative embodiments have been shown and described herein, the same is illustrative only and not restrictive in character. It should be understood that only representative embodiments have been described, and that any and all: additions, advantages, alterations, apparatus, applications, aspects, benefits, changes, components, compositions, constituents, deletions, devices, embodiments, equivalents, features, forms, implementations, materials, methods, modifications, objects, operations, options, processes, refinements, structures, substitutions, subtractions, systems, techniques, and variations that come within the spirit, scope, and/or meaning of any inventions defined herein, including any of the following claims, are desired to be protected.

What is claimed is:

1. A method, comprising:
employing an enclosure comprised of a pliable rodent barrier resistant to rodent passage therethrough, the enclosure including a base defining a base margin and an envelope defining an envelope margin;
moving a ground vehicle to rest on the base with the base margin at least partially surrounding the ground vehicle and the envelope positioned out from under the base and the ground vehicle;
covering the ground vehicle on the base with the envelope to position the base and the envelope approximately opposite each other and to bring together the base margin and the envelope margin; and
joining the base margin and the envelope margin to envelop the ground vehicle inside the enclosure and isolate the ground vehicle from rodents outside the enclosure.

2. The method of claim 1, in which the barrier includes an inorganic material structured and composed to resist biting, chewing, scratching, digging, tunneling, gnawing, pawing, and clawing by the rodents to form the passage through the barrier.

3. The method of claim 1, in which the barrier includes a gas permeable arrangement comprising one or more of:
(a) inorganic fibers, hardware cloth; steel wool; stainless steel wool cloth; galvanized steel wool; metal fibers; PVC coated wire mesh; a blend of stainless steel wool interwoven with polymer fibers; metal oxide fiber; analogs thereof; fabrics thereof; and polymeric resin composites thereof; and
(b) carbon fiber, glass fiber, para-aramid synthetic fiber, meta-aramid synthetic fiber, UHMWPE fiber, elemental metal, alloy, metal, or metallic-coating thereof; analogs thereof; fabrics thereof; and polymeric resin composites thereof.

4. The method of claim 1, in which the barrier includes a lamination comprised of two or more laminae, the laminae including a first lamina and a second lamina being composed in accordance with one of (a) through (d) as follows:
(a) the first lamina including a pattern of ceramic pieces and the second lamina including a water-resistant synthetic organic polymer configured as a suitable pliable fabric or sheet of material, including but not limited to: nylon; PBI; UHMWPE; HDPE; MDPE; LDPE; XLPE; PEX; polyester; PET; PP; and PVC; analogs thereof, and polymeric resin composites thereof.
(b) the first lamina including one or more of: a liquid permeable arrangement of inorganic fibers, a liquid permeable arrangement of thermoplastic fibers, and a liquid permeable arrangement of thermoset fibers; and the second lamina including at least one of a water resistant: fabric, thermoplastic polymer film, thermoset polymer film, thermoplastic polymer sheet, thermoset polymer sheet, thermoplastic polymer coating, and thermoset polymer coating;
(c) the first lamina including a composite of inorganic fibers and a polymeric resin and the second lamina being one or more of: a thermoplastic polymer layer and a thermoset polymer layer;
(d) the first lamina including one or more of: steel wool, stainless steel wool, and galvanized steel wool; metal oxide; carbon fiber; carbon fabric; ceramic; ceramic-glass; glass; para-aramid synthetic fiber; meta-aramid synthetic fiber; UHMWPE; metal fiber structured as one or more of a knit, woven, and knotted fabric with a pattern of openings; metal wire structured as one or more of: a hardware cloth, a mesh and a screen; and the second lamina including one or more of a: fabric, thermoplastic polymer layer, thermoset polymer layer, and a composite of fibers and a polymeric resin; and
to the extent the laminae are greater than two, each of the laminae numbering more than two may be composed the same or different than any of the first lamina and the second lamina.

5. The method of claim 1, which includes:
extending over a base surface area as the ground vehicle rests thereon, the base surface area corresponding to a vehicle footprint portion of the base;
surrounding the vehicle footprint portion with a peripheral portion of the base; and
during the covering of the ground vehicle, pivoting the envelope relative to the base.

6. The method of claim 5, in which:
the base margin terminates with a row of base zipper teeth and the envelope margin terminates with a row of envelope zipper teeth; and
the joining of the base margin and the envelope margin includes:
meshing together the base zipper teeth and the envelope zipper teeth to define a zipper chain of a closed zipper;
uniting the base and the envelope with the closed zipper; and
through cooperation of the closed zipper and the barrier, safeguarding the ground vehicle inside the enclosure from the rodents outside the enclosure.

7. The method of claim 6, in which:
a first end of the base zipper teeth meet a first end of the envelope zipper teeth with a first zipper stop;
a second end of the base zipper teeth meet a second end of the envelope zipper teeth with a second zipper stop, the first zipper stop being positioned generally opposite the second zipper stop;
a region of the barrier extends across the enclosure to connect the envelope and the base together; and
the pivoting of the envelope relative to the base includes flexing the region of the barrier to define a hinge from the region of the barrier with a pivot axis approximately parallel to or coincident with a straight line transversely extending between the first zipper stop and the second zipper stop;

8. The method of claim 7, which includes
providing the ground vehicle as a form of motor coach; and
operating a two-way closed-end zipper configuration defined with the base zipper teeth, the envelope zipper teeth, the first zipper stop, the second zipper stop, and at least one slider to open and close the enclosure.

9. A method, comprising:
arranging an enclosure to prepare for ground vehicle engagement therewith, the enclosure being comprised of a pliable pest barrier material resistant to pest passage therethrough, the enclosure including two or more enveloping portions, a first one of the enveloping portions defining a first margin and a second one of the enveloping portions defining a second margin;
after the arranging of the enclosure, engaging the enclosure with a ground vehicle, including placement of a ground vehicle in contact with an interior of one or more of the enveloping portions, the ground vehicle including a number of different wheels, a different portion of the enclosure being positioned under each of the different wheels after the engaging of the enclosure with the ground vehicle; and
enclosing the ground vehicle with the enveloping portions, including connecting the first margin and the second margin together with a fastener operable to open and close an opening between the first margin and the second margin, the fastener cooperating with the barrier material to isolate the ground vehicle inside the enclosure and keep pests outside the enclosure.

10. The method of claim 9, in which the barrier is comprised of one or more of: an inorganic substance and synthetic organic polymer fiber structured and composed to resist biting, chewing, scratching, gnawing, digging, tunneling, clawing, and pawing by pests in the form of rodents including: rats, mice, woodchucks, tree squirrels, ground squirrels, marmots, chipmunks; moles; shrews; opossums; bats; skunks; and raccoons.

11. The method of claim 10, in which:
the inorganic substance comprises one or more of: metal fiber, metal-coated fiber, ceramic, ceramic-glass, carbon fiber, and inorganic oxide; and
the synthetic organic polymer fiber comprises one or more of: para-aramid, meta-aramid, and UHMWPE fibers; woven or nonwoven fabric comprised of any of these fibers; and analogs and composites thereof.

12. The method of claim 11, in which:
the metal fiber comprises one or more of: woven and nonwoven metal fabric; hardware cloth; metal mesh, and metal screen; and PVC-coated metal;
the metal-coated fiber comprises one or more of: steel wool, stainless steel wool, galvanized steel wool; entangled stainless steel wool and polymeric fibers; analogs thereof; fabrics thereof; and polymeric resin composites thereof;
the ceramic and ceramic-glass comprises one or more of: a pattern of spaced apart ceramic pieces laminated on a water-resistant polyester fabric; ceramic fibers, woven or nonwoven fabrics thereof, and polymeric resin composites thereof; ceramic-glass fibers, woven or nonwoven fabrics thereof, and polymeric resin composites thereof;
the carbon fiber comprises one or more of: woven and nonwoven carbon fiber fabrics and polymeric resin composites thereof; and
the inorganic oxide comprises one or more of: glass and metal oxide; fibers and fabrics thereof; and polymeric resin composites thereof.

13. The method of claim 9, in which:
the barrier material is comprised of a lamination including multiple laminae;
a first one of the laminae is comprised of one or more of: metal fibers, metal-coated fibers, ceramic fibers, ceramic-glass fibers, carbon fibers, inorganic oxide fibers; para-aramid, meta-aramid, and UHMWPE fibers; woven and nonwoven fabric thereof; mesh thereof; screen thereof; polymeric resin composite thereof; spaced-apart ceramic pieces; and spaced-apart ceramic-glass pieces; and
a second one of the laminae is comprised of one or more of a water resistant: fabric, thermoplastic polymer layer, thermoset polymer layer, and a composite including a polymeric resin and one or more of: inorganic fibers, para-aramid fibers, meta-aramid fibers, and UHMWPE fibers.

14. The method of claim 9, in which the enveloping portions are connected together, the first one of the enveloping portions defines a base, the engaging of the enclosure includes moving the ground vehicle onto the base, the fastener including a first row of zipper teeth along the first margin and a second row of zipper teeth along the second margin, and the connecting of the first margin and the second margin together includes meshing the first row of zipper teeth and the second row of zipper teeth to define a zipper chain of the fastener closing the opening, and the fastener is a two-way closed-end zipper configuration including at least one zipper slider.

15. A method, comprising:
providing a pliable bag comprised of a mammal pest barrier, the barrier being resistant to mammal pest passage therethrough, the bag being sized and shaped to receive a ground vehicle;
establishing access to an interior surface of the bag;
by way of the access, moving the ground vehicle into the bag to rest on the interior surface thereof, the ground vehicle including a number of wheels and the bag being positioned under the wheels; and
while the ground vehicle is resting on the interior surface with the bag positioned under the wheels, closing the bag to envelop the ground vehicle inside the bag and isolate the ground vehicle from mammal pests outside of the bag.

16. The method of claim 15, in which the mammal pest barrier includes inorganic fibers.

17. The method of claim 15, in which the mammal pest barrier is comprised of one or more of: inorganic fibers; metal-coated wool fibers; para-aramid fibers, meta-aramid fibers, UHMWPE fibers, and fiber analogs thereof; fabric comprised thereof; polymeric resin composites thereof; spaced-apart ceramic pieces; and spaced-apart ceramic-glass pieces,

18. The method of claim 15, which includes zipping closed one or more zippers attached to the bag to perform the closing of the bag.

19. The method of claim 18, in which:
the bag includes a first margin portion terminating in a first zipper teeth row and a second margin portion terminating in a second zipper teeth row;
the closing of the bag includes:
positioning the first zipper teeth row opposite the second zipper teeth row;
meshing together the first zipper teeth row and the second zipper teeth row to define a zipper chain of a closed zipper;
uniting the first margin portion and the second margin portion together with the closed zipper; and
through cooperation of the closed zipper and the barrier, safeguarding the ground vehicle inside the bag from the mammal pests outside the bag.

20. The method of claim 19, in which the closed zipper is of a two-way closed-end zipper configuration including a first zipper stop, a second zipper stop, and at least one zipper slider.
